(19) United States
(12) Patent Application Publication
(10) Pub. No.: US 2010/0127432 A1
(43) Pub. Date: May 27, 2010

(54) METHOD FOR PRODUCTION OF CANDLES

(75) Inventors: Bertus Michiel Wagenaar, Hamont-Achel (BE); Dimitri Van Nuland, Hamont-Achel (BE)

Correspondence Address: SUGHRUE MION, PLLC, 2100 PENNSYLVANIA AVENUE, N.W., SUITE 800, WASHINGTON, DC, 20037, US

(73) Assignee: SPAAS KAARSEN, Hamont-Achel (BE)

(21) Appl. No.: 12/596,284

(22) PCT Filed: Apr. 17, 2008
(86) PCT No.: PCT/BE2008/000029

§ 371 Date: Dec. 16, 2009

(30) Foreign Application Priority Data
Apr. 17, 2007 (BE) 2007/0184

(51) Int. Cl. C11C 5/00; B29C 47/36; B29C 39/14

(52) U.S. Cl. 264/401; 44/275; 264/176.1; 264/211; 264/214

(57) ABSTRACT

Method for production of candles wherein at least two fuel components are mixed together which before mixing each have a different temperature and which are the same or different in chemical composition. The first fuel component has a high temperature, wherein this is too plastic or fluid to be able to be processed or packed as a candle. The second fuel component has a lower temperature and is preferably granular whereby this functions as a cooling means to bring the first fuel component to hardening or setting.

Current candle production technology results in high operating costs and is often inflexible in relation to the type of raw material that can be processed.

The casting process is a common process in which the raw material is supplied in fluid form. Then the cooling heat and crystallisation heat must be dissipated to give the candle sufficient rigidity for the subsequent process treatment such as packing. However cooling a cast candle with a relatively large diameter, for example a diameter of 70 mm, takes several hours, which results in high production cost for such candles. In addition during cooling shrinkage occurs, and the crystallisation process can lead to local crystallisation patterns on the surface.

Another process is compressing a pulverized raw material. One problem with this process is not that every raw material can be compressed well. Hardened stearin powder or hardened fat granulate cannot in practice be compressed into a sufficiently rigid candle. Solutions such as the addition of plastic substances increase the cost price of the candle. In addition pulverization of the fluid raw material by means of cooled drums or spray chambers is a costly pre-treatment step. The same reason applies to the extrusion of candles from the pulverized fuel.

The object of the invention is the preparation of a new type of candle raw material which hardens quickly, while in the hardening step a small quantity of heat or preferably almost no heat must be dissipated.

In this way arbitrary candle forms can be cast and because of the short cooling time, with a production device of limited size, large production volumes can be achieved.

According to the invention the new type of candle raw material known as candle sludge comprises at least two components which are not thermally balanced. Before mixing of the two components, the first fuel component has a first temperature at which this fuel component is too plastic or too fluid to be processed into a candle without further cooling. The second fuel component has a lower temperature so that this functions as a cooling medium to accelerate the hardening or setting of the first fuel component.

The first fuel component is preferably a warm, fluid mass which may be partly crystallised, wherein the crystallisation percentage can vary between 0 and 100 w. %. The second fuel component is preferably a colder, solid mass which is preferably pulverized and/or granulated into a granulate. Thorough mixing of the two constituents gives a mixture that can be formed as long as the warm fluid coating has not set around the cold grains. Colours and fragrances can be added to both phases. The heat exchange process between the warm plastic mass and the cold granulate is characterised by a length dimension which is proportional to the grain or granulate diameter. Preferably the solid, granular fuel component has a mean particle size which is smaller than 30 mm, preferably smaller than 10 mm and more preferably smaller than 2 mm, wherein the mean particle size of the solid granular fuel component is preferably greater than 0.001 mm, more preferably greater than 0.1 mm. The mean particle size is thus preferably included between 0.1 and 10 mm, more preferably between 0.2 and 2 mm, and even more preferably between 0.3 and 1.5 mm. The smaller the granulate diameter, the faster the heat exchange. The granulate particularly preferably has a mean particle size which is less than 1 mm. The characteristic length of the heat transfer process is then small and the specific heat exchange surface is large. Thus the hardening process takes place in a short period, whereby large production volumes can be obtained per unit process equipment.

The granular fuel component preferably has a melting point measured to ASTM 938 which is lower than the temperature of the first fluid fuel component. The granular fuel component here partly melts after mixing with the first fuel component during hardening or setting of the first fuel component and can thus extract more heat from the first fuel component. The granular fuel component preferably has a melting point measured to ASTM 938 which is lower than or equal to the melting point of the first fuel component also measured to ASTM 938.

To be able to accelerate the hardening process further, on production of the candles hollow channels can be provided through which a coolant (gas or liquid) can flow.

In a preferred embodiment the temperature of the second fuel component, before mixing the fuel components, is at least 5, preferably at least 10, more preferably at least 15 and highly preferably at least 20° C. lower than the melting point of the first fuel component. The temperature of the first fuel component is for example 45 to 65° Celsius while the temperature of the second fuel component is for example −30 to +30° Celsius. The second fuel component can for example be adapted approximately to ambient temperature. Per 100 weight parts of fuel component mixture, preferably 5 to 90 weight parts, more preferably 20 to 80 weight parts of the second fuel component are used. If the fuel mixture is extruded, of a total of 100 weight parts preferably 50 to 75 weight parts of the second fuel component are used.

A gas can be incorporated in one or more of the fuel components or in the mixture thereof in order to achieve a density reduction. The fuel components can comprise paraffin, fatty acids, fat and a low molecular polymer and/or gelling agents or mixtures thereof. In addition to the first and second fuel components described above, further fuel components may be used. These can either form a further first fuel component which is too plastic or too fluid to be processed without cooling into a candle, or a further second fuel component which has a lower temperature than the first fuel component(s), whereby this further second fuel component also functions as a cooling means to bring the first fuel component(s) to hardening or setting.

The sludge mixture, with a rheology which shows some similarity to toothpaste or dough, can be processed into in many forming machines. Non-limitative examples are:
the free outflow from an opening or tube whereby an extruded candle form is obtained
the filling of moulds such as tea-light holders or glazed moulds
as a feed from a 3D printer
as a feed for single or multi-screw extruders or co-extrusion machines.

Subsequent processing stages such as smoothing of the candle surface or printing of the candle surface are provided.

Some non-limitative examples are given below.

### EXAMPLE 1

First the first fuel component was produced by bringing 0.65 kg stearin 0436 by Oleon to a temperature of 60° Celsius, which is just above the setting point of this stearin. The second fuel component consists of 0.35 kg of a powder of the same stearin 0436 by Oleon with a temperature of 20° Celsius and the grains of which have a mean diameter of 0.65 millimetres. By means of a mixing and kneading device, the two fuel components are intensively mixed for 60 seconds, forming a paste-like mixture. This mixture is pressed into a cylindrical mould with a diameter of 50 millimetres which is fitted with a wick placed on the centre line. After 10 minutes cooling in air, the hardened candle can be removed from the mould.

### EXAMPLE 2

First the first fuel component is produced by bringing paraffin 5803 from Exxon to a temperature of 62° Celsius, which is just above the setting point of this paraffin. The second fuel component consists of a powder of the same paraffin 5803 from Exxon with a temperature of 20° Celsius and a mean grain diameter of 0.65 millimetres.

First the cold, solid powder is bought into the extrusion screw, after which the fluid is admixed in an axially downstream position. The extrusion mixture leaves the extruder at the screw end and then passes through a cold liquid bath at 15° Celsius in order to create directly a hard candle skin.

It is noted that the axial feed positions for both fuel components can be varied along the extruder shaft and are even interchangeable.

1. Method for producing candles, characterised in that at least a first and a second fuel component are mixed together which before mixing each have a different temperature, and which are the same or different in chemical composition, wherein
the first fuel component has a first temperature at which this is too plastic or fluid to be able without cooling to be processed and packed as a candle, and
the second fuel component has a lower temperature, whereby this functions as a cooling means in order to bring the first fuel component to hardening or setting.

2. Method according to claim 1, characterised in that the first fuel component comprises a warm fluid melt while the second fuel component comprises a solid granular fuel component which is colder than the first fuel component and thus brings the first fuel component to hardening or setting.

3. Method according to claim 2, characterised in that the second fuel component has a melting point measured to ASTM 938 which is lower than the first said temperature.

4. Method according to claim 2, characterised in that the second fuel component has a melt point measured to ASTM 938 which is lower than or equal to the melt point of the first fuel component, also measured to ASTM 938.

5. Method according to claim 2, characterised in that the granular fuel component after mixing with the first fuel component partly melts during the hardening or setting of the first fuel component.

6. Method according to claim 2, characterised in that the solid granular fuel component has a mean particle size which is smaller than 30 mm, preferably smaller than 10 mm and more preferably smaller than 2 mm, wherein the mean particle size of the solid granular fuel component is preferably greater than 0.001 mm, more preferably greater than 0.1 mm.

7. Method according to claim 1, characterised in that per 100 weight parts fuel component mixture, 5 to 90 weight parts, preferably 20 to 80 weight parts of the second fuel component are used.

8. Method according to claim 1, characterised in that colourings and fragrances and one or more wicks are added to one or both fuel components.

9. Method according to claim 1, characterised in that each of the two fuel components comprises one or more components selected from the group containing paraffin, fatty acids, fat and low molecular polymer and/or gelling agents.

10. Method according to claim 1, characterised in that a gas is also incorporated in order to obtain a density reduction.

11. Method according to claim 1, characterised in that the second fuel component is cooled cryogenically before mixing.

12. Method according to claim 1, characterised in that before mixing the two fuel components, the temperature of the second fuel component is at least 5, preferably at least 10, more preferably at least 15 and highly preferably at least 20° C. lower than the melting point of the first fuel component measured to ASTM 938.

13. Method according to claim 1, characterised in that the fuel component mixture is processed in an extruder, in a candle casting machine or in a 3D printer, wherein one or more wicks are introduced into the mixture and wherein subsequent cooling may be applied in order to harden the skin of the candle in a short time.

14. Method according to claim 1, characterised in that the fuel component mixture is co-extruded, wherein optionally hollow channels are introduced or a foam or powder filling of internal parts of the extruded candle.

15. Method according to claim 1, characterised in that a device is used with two or more process parts, wherein the first process part is intended for the homogenous mixing of the two fuel components and the second process part for the forming process of the candle, and wherein further process parts may follow or be interposed which concern subsequent processing stages or heat transfer stages.

16. Method according to claim 1, characterised in that on production of the candles hollow channels are provided in the candles through which a cooling medium can flow so that the residual heat in the candle body is dissipated more quickly.
